(19) United States
(12) Patent Application Publication
(10) Pub. No.: US 2009/0159102 A1
(43) Pub. Date: Jun. 25, 2009

(54) PARTS WASHER

(75) Inventors: Dennis Mount, Ottawa (CA); Mathieu Fredette, Gatineau (CA)

Correspondence Address: TODD S. PARKHURST;HUGHES SOCOL PIERS RESNICK & DYM LTD., THREE FIRST NATIONAL PLAZA, 70 WEST MADISON- SUITE 4000, CHICAGO, IL, 60602, US

(73) Assignee: ChemChamp LLC, Ottawa (CA)

(21) Appl. No.: 12/268,102

(22) Filed: Nov. 10, 2008

Related U.S. Application Data
(60) Provisional application No. 60/986,797, filed on Nov. 9, 2007.

(51) Int. Cl. B08B 3/04; B08B 3/08; B01D 3/00

(52) U.S. Cl. 134/94.1; 134/56 R; 202/152

(57) ABSTRACT

A parts cleaner for use in a process whereby solvent is preferred to always be available and is preferred to be as clean or pure as possible for use, comprising two containers respectively for clean solvent and for capture of used solvent or a single container having separate zones for clean and used solvent, said clean container having an outlet for supplying clean solvent for cleaning. The clean container may have an outlet for supplying clean solvent for cleaning and an inlet for clean recycled solvent, the used solvent container having an inlet for used solvent, an outlet for supplying used solvent for cleaning and an outlet for supplying used solvent for recycling. The used solvent container may have an outlet for supplying used solvent for cleaning and means for automatically switching between the outlets supplying said clean solvent and said used solvent for cleaning. The clean container may have an inlet for clean recycled solvent, the used solvent container having an inlet for used solvent, an outlet for supplying used solvent for cleaning and an outlet for supplying used solvent for recycling, the parts cleaner being adapted to draw first from the clean solvent container and drain into a separate used solvent container and when clean solvent is not available, to draw from the used solvent container, thus ensuring availability of solvent at all times. Also disclosed is a solvent recycler having a distillation chamber and a filling system for the distillation chamber or a distillation zone of the distillation chamber without the use of valves when filling the distillation chamber from a used solvent zone or a container for a batch or continuous system.

This application claims priority from U.S. provisional application Ser. No. 60/986,797 filed Nov. 9, 2007.

### FIELD OF THE INVENTION

The present invention relates to a fluid management and recycling system which may be used as a parts washer for use in automotive, industrial and institutional facilities and similar establishments where parts are cleaned by application of solvent.

### BACKGROUND OF THE INVENTION

Typically, a parts washer has a sink that has a hose to draw solvent from a drum for cleaning the part. The used solvent drains back into the same drum. The system is set up this way to ensure solvent is always available for use. However, the problem is that used solvent from cleaning the part draining into the clean solvent dirties the solvent in the drum, and thus the cleaning of the next part will be with dirty solvent, making it more labor intensive. The solvent becomes dirtier and dirtier with each use, increasing the required labor more and more with each use. This continues until the solvent is unusable and the drum is removed and replaced with a drum filled with clean solvent by the user or service provider. The user desires to clean with clean solvent preferably every time or at least have access to clean solvent for a final rinse.

In the event the user is removing the dirty drum and replacing it with a clean drum filled with clean solvent to continue the process, the user must collect the used solvent drums and pay to have them picked up and then, as well, continue to purchase clean solvent. This process is very time consuming, costly and requires a service provider with a massive trucking and distribution system.

One attempt to improve upon this system is described in U.S. Pat. No. 5,349,974 assigned to Mansur Industries Inc. Referring to FIG. 1, Mansur teaches a general parts washing apparatus 110 which includes a cabinet 112 including an upper portion defining a wash basin 114 and a lower portion 116 including a rear wall 119 and a front wall 120. The front wall 120 is at least partially comprised of a door which provides access to the cabinet interior. The floor 126 in the wash basin 114 is sloped from the sides, rear and front, downwardly towards a central zone where there is located a drain 128, through which solvent drains after use for washing articles in the basin 114. After passage through the drain 128, the solvent is directed through a filter 130 and through a return canal 132 which leads to a solvent holding tank 400. A motor-driven vapour containment valve 134 is provided at the connection of the return canal 132 to the solvent holding tank 400. During periods of non-use, the vapour containment valve 134 is closed, thus preventing solvent vapours from escaping to atmosphere from within the holding tank. The holding tank 400 is sized and configured to contain a predetermined amount of solvent therein for continuous recycling and reuse during cleaning operations.

A pump 144 within the holding tank 400, located at a bottom thereof, recirculates the solvent in the holding tank through a return conduit leading to a three way valve interconnecting between the return conduit and a spout 150 and a hose 152 having a wash brush 154 attached to an end thereof. Once discharged from the spout 150 for rinsing the various articles being cleaned, the solvent returns to the holding tank through the drain 126 and return canal 132.

After daily parts washing operations, or on such other time intervals as may be desired, the solvent contained within the holding tank 400 (now contaminated after use for washing various articles in the wash basin) is released through a transfer canal 158 into a distillation pot 160 located in a lower portion of the cabinet interior. At the initiation of a timed solvent recycling process, the vapour containment valve 134 is closed, thus preventing the vapours from escaping to atmosphere. Simultaneously, a motor-driven solvent containment valve assembly 166 is opened to release contaminated solvent from the holding tank through the transfer canal 158 leading to the distillation pot 160.

The distillation pot 160 includes a double wall structure around the sides and bottom including an inner wall 190 and bottom 192 and outer wall 94 and bottom 196 having insulation 198 disposed therebetween. A removable lid 100 is suspended within the cabinet and to facilitate removal and attachment of the lid 100 in sealed engagement over an open top of the distillation pot, a removal assembly 104 is provided including a wheel 106 having a plurality of arms 107 extending therefrom and a vertically oriented threaded stem 108 which threadably engages within a threaded, hollow, concentric bore 210 extending at least partially through a central vertical post 212 of the distillation pot 160. The wheel 106 remains supported upon a platform 214 on the top of the lid 100 with the threaded stem 108 extending downwardly therethrough for threaded engagement within the threaded bore 210 of the central post 212 of the distillation pot 160. Upon rotation of the wheel 106 in a particular direction, by grasping the arms 107 and pulling, the threaded stem 108 may be caused to threadably advance within the hollow bore 210 of the central post 212, resulting in the distillation pot 160 being raised towards the lid 100 until a top edge 220 of the side wall of the pot 160 mates with an under side 222 of the lid. Alternatively, rotation of the wheel in an opposite direction results in lowering of the distillation pot 160, effectively removing the lid.

In order to initiate threaded engagement of the stem 108 within the hollow bore 210 of the central post 212 upon attaching the lid to the distillation pot, a cam lever assembly 230 is provided including a shaft 232 having a first end 234 with a knob 235 attached and an opposite end 236 fitted to a cam member 238 which is pivotally attached to a support bracket 240 above the wheel 106. Upon inward movement of the shaft 232 by pressing inwardly on the knob 235, the cam member 238 is caused to rotate such that one end of the cam member 238 forces the wheel 106 and threaded stem 108 downwardly into threaded engagement with the threaded bore 210 of the central post. To remove the lid, the knob 234 and attached shaft 132 are pulled outwardly, causing the cam 238 to rotate out of engagement with the wheel. Upon disengagement of the threaded stem 108 from within the central post, the biasing means urges the wheel 106 and stem 108 upwardly to clear the central post 212 and upper edge 220 of the side walls of the distillation pot 160.

A plurality of heating elements 150 are provided in the distillation pot 160, including preferably four heating elements attached to the underside of inner bottom 192 of the distillation pot and a fifth heating element 150′ disposed within the central post. The heating elements 150, 150′ are activated during the recycling process in order to boil the solvent to produce vapours.

A condenser tube includes a first end attached through the lid 100 in fluid communication with an interior of the distillation pot 160 and an opposite end 164 connecting to the solvent holding tank and a vacuum pump 280 within the cabinet interior interconnects to the holding tank 400 for creating a vacuum in the holding tank 400 and distillation pot 160 via the interconnecting condenser tube.

This system has a number of disadvantages, amongst which the following are notable.

Firstly, the holding tank can never have pure clean solvent available, unless the washing operation is stopped to allow all used solvent to drain from the holding tank into the distillation pot and to allow sufficient time for the recycling process to generate clean recycled solvent which is introduced into the tank. Secondly, the holding tank is not removable, which means that if it requires repair for any reason, the apparatus must be dismantled or replaced entirely. Thirdly, the apparatus operates under vacuum within the holding tank and distillation pot, with the attendant complexities and risk of vacuum leaks and also uses a complicated motor driven valving arrangement which can be a source of malfunction due to exposure of the valve elements to contaminated solvent. Fourthly, the heating elements are located in the bottom of the distillation pot, which is where the sludge from the distillation accumulates. Therefore, the heating elements are operating within the sludge, which obvious adversely effects their efficiency, unless the sludge is removed frequently, which involves opening the distillation pot and manually scraping out the sludge.

In addition to the foregoing, the problems with Mansur may be summarized as follows:
a) The solvent used to clean parts drains into the same solvent being drawn to clean the next part. Therefore the cleaning solvent becomes dirty upon cleaning the first part.
b) The user is interrupted from using the parts cleaner while the system takes the required time to dump dirty solvent and replenish with clean.
c) The dumping and replenishing system uses pressure actuated valves which are sensitive to failure, especially due to their exposure to dirty solvent.
d) The system requires an extra holding tank for recycled solvent to ensure clean solvent is available to replenish the parts washer solvent container.
e) The system must have one batch of clean solvent ahead in order to have solvent available for replenishing. If it does not, then upon the user initiating dumping of used solvent from the parts washer container, no solvent would be available to the container, therefore causing the user to not have washing solvent available for use.
f) None of the containers are removable. Therefore, if any of them leak or become encumbered with sludge, the entire unit must be dismantled to replace it, since cleaning of the containers would be very difficult.

Another approach to providing a parts washer with solvent recycling is described in U.S. Pat. No. 6,279,587 to Yamamoto, which teaches a parts washer provided with a sink, a drum of solvent, and a recirculating system for pumping the solvent from the drum through a hose or nozzle arrangement for spraying the solvent on the parts to be washed in the sink, and then allowing the solvent to drain from the sink back into the solvent drum. The solvent drum is fitted with an extra clean-out tube for withdrawing contaminated solvent from the drum, and a return tube for replenishing the drum with clean solvent. The clean-out tube and return tube are fitted with quick-connect couplings for releasability and/or attaching solvent cleaning apparatus thereto, such as filtration or distillation type recycling apparatus.

Referring to FIG. 2, Yamamoto teaches a parts washer 310 includes a cleaning sink 312 with a bottom wall 314 that slopes downwardly to a sink drain 316. Sink drain 316 includes an optional valve 318 to close the drain. Sink 312 includes a wire mesh support filter screen 319. A filter pad 321 of relatively coarse material is located on top of support screen 319 to prevent large pieces of debris from passing through drain 316 into a solvent container or drum 320, which is located below sink 312 and typically contains from about 10 to 17 gallons of solvent 322. Container 320 has a container wall 323 including an upper wall portion 324, which defines an inlet opening 326 for receiving solvent from sink drain 316 when valve 318 is open. Container wall 323 also has a conical bottom wall portion 328. An extraction conduit 330 extends into solvent container 320 and extends through container wall 324 for withdrawing solvent from container 320. Extraction conduit 230 has a lower inlet strainer 332, which is formed of relatively course mesh to prevent foreign particles over 2 to 3 mil. from entering extraction conduit 330.

Extraction conduit 330 includes a suction line 331, an inlet suction hose 336, and an outlet hose 346. Suction line 331 is connected by a quick-connect type connector 334 to inlet suction hose 336 leading to a pump 338. An optional swivel connector 340 may be located in inlet suction hose or line 336, in which case, quick-connect coupling 234 may be replaced with a regular threaded connector, or both quick-connect connector 334 and swivel connector 340 could be used together if desired. Quick-connect connector 234 and/or swivel connector 340 are used to facilitate removal of container 220 from parts washer 310.

Outlet hose or conduit 346 supplies solvent from pump 338 to a solvent delivery tube 348 attached to or located in sink 312. Delivery tube 348 delivers the solvent to a manifold 350 which includes a three-way valve 352 for directing the solvent to a flexible outlet tube 354 and/or a flexible hose 356. Outlet tube 354 has an outlet nozzle 358 for directing or spraying solvent onto a part to be washed in sink 312. Flexible hose 356 supplies solvent through a cleaning brush 360.

Container 320 also includes a clean-out tube 366, which passes through container sidewall 368. Clean-out tube 366 extends to a location adjacent to the container bottom wall portion 328 to suck out any debris or solid contaminates 370 from the bottom of container 320. The lower end portion or inlet 372 of clean out tube 366 must be below the surface of solvent 322 during all normal operating levels of solvent 322.

Clean-out tube 366 also has an outlet end portion 374 located outside container 320, and a quick-connect coupling 376 is provided on the end of outlet end portion 34 for attaching clean-out tube 366 to the inlet to a recycling unit or apparatus.

Container 320 is also provided with a return tube 378 passing through container wall 368. Return tube 378 also has a quick-connect coupling 380 mounted thereon for attaching return tube 378 to the outlet of a recycling unit.

Quick-connect couplings 376, 380 are the female components of these type of couplings and thus are normally closed to prevent solvent 322 from escaping through clean-out tube 366 and return tube 378 even where the level of solvent 322 rises above tubes 366 and 278.

When pump 338 is activated, solvent 322 is circulated from container 320, through pump 338 to solvent delivery tube 348 and thus either to nozzle 358 or cleaning brush 360. The solvent then drains through sink drain 316 and returns to container 320.

Solvent container 320 is mounted on a dolly 394, so that container or tank 320 can be pulled out and replaced with another tank or drum.

Sink 312 is mounted on a base or cabinet 416, so that container 320 can be replaced without having to lift or move sink 312. Base or cabinet 416 includes an access opening 418 to allow hoses to pass therethrough from a solvent reservoir or a solvent recycling unit to be connected to quick-connect couplers 376, 380.

A tank level indicator 381 in the form of a sight glass is provided to indicate the level of solvent 322 in container 320.

In this system, the drum can never have pure clean solvent available, because it would be virtually impossible for all used solvent to be withdrawn from the drum into the recycler, even if the washing operation were stopped to allow sufficient time for drum to be emptied and for the recycling process to refill the drum with clean recycled solvent. In fact, there is no suggestion in the Yamamoto patent to operate with clean solvent alone but only with a mixture of used and recycled solvent.

In addition to the foregoing, the problems with Yamamoto may be summarized as follows:
a) The solvent is never clean as the used solvent drains into solvent being drawn to clean parts.
b) The clean solvent coming from recycler is never able to be used as clean as it mixes with used solvent.
c) Recycling efficiency is drastically lowered as the clean solvent from the recycler is mixed with the same used solvent being drawn into recycler.

A first object of the present invention is to provide a parts washer which at least mitigates the problems associated with prior art devices as exemplified by the foregoing patents.

A second object of the invention is to provide a novel recycler which may be used apart from or integrated with the novel parts cleaner and which obviates the disadvantages of conventional recyclers, such as that described in the aforementioned Mansur patent, which use potentially troublesome valving arrangements and bottom heating and which do not provide for automatic removal of the waste.

### SUMMARY OF THE INVENTION

In a first aspect, the present invention provides a novel parts cleaner for use in a process whereby solvent is preferred to always be available and is preferred to be as clean or pure as possible for use. The invention provides two containers, one for clean solvent and the second for capture of used solvent. The containers are preferably, but not necessarily, removable. Alternatively, a single container having separate zones for clean and used solvent may be used. The system draws first from the clean solvent container and drains into a separate used solvent container. In the event clean solvent is not available, the system will draw from the used solvent container, thus ensuring availability of solvent at all times. Used solvent through an outlet extending from the bottom of the used solvent collection zone/container may be introduced to a recycler and returned through an inlet to the clean solvent container from which the system will begin to draw upon availability of the clean solvent, whereby the cleanest solvent is always used first and the used solvent, if ever needed to be used, is ensured to be as clean as possible.

Preferably, the system allows for clean solvent to accumulate to a certain volume before initiating draw for use. The method of initiating clean solvent as the first draw may be via any sensing means, whether it be mechanical or with software and or the combination of both. The means for switching the draw from clean or used solvent may be accomplished manually by the user. The trigger to replenish clean could be initiated by detection of used solvent in the used container or by any means which is able to be used in conjunction with appropriate software. The system may have no trigger based on levels or volumes and indeed there may be no trigger to recycle whatsoever. The recycler itself may simply have to be turned on by the user or the recycler could have its own trigger, for example, its own timer. The trigger to recycle solvent could be a timer or any measure of use with or without software or the trigger to initiate recycling could be manual.

The system could be attached to any recycler including those described in our U.S. applications Nos. 10/030,027 and 10/537,316, the entire contents of which are incorporated herein by reference. The system may be provided with a pump or other suitable mechanism in order to pump used solvent into a recycler.

The system may have one drum sitting inside the other drum, an advantage being that the parts cleaner would need only one pump as compared to two. The one pump would sit in the clean portion. The disadvantage in this arrangement is that the used solvent container would need to be of a smaller volume than the clean drum so as to ensure a certain amount of overflow to ensure solvent is always available for use, thus leading to the possibility of used solvent dirtying the clean. However, this arrangement would still be an improvement over the prior art as any overflow into the clean container would be the cleanest of the used solvent, and this would only happen if the recycler was not fast enough. However, even if the recycler is not fast enough, the recycler would still benefit from sucking in the dirtiest used solvent from the bottom of the used solvent and it would not be sucking clean solvent being put into a separate container.

Remote monitoring of the system may be provided for service purposes. It would be a advantageous if, for example, the unit could indicate automatically over the internet or phone to a service provider when it needs service. This is better than guessing when the customer or service provider needs to set up service terms. It would streamline the whole service process and give the customer guaranteed service when needed without the customer having to call for service. Alternatively, the unit could also have a button or the like, linked remotely to the service provider, which the customer could press when service is needed.

In a further aspect of the invention, there is provided a novel recycler which provides a filling system for the distillation chamber or distillation zone of the distillation chamber without the use of valves when using a pumping mechanism to draw liquid from a used solvent container into the distillation chamber for a batch or continuous system.

The novel recycler may have a level indicator, which preferably does not use any mechanical device that can be problematic due to the effects of heat and process chemicals and the limited space in the distillation chamber environment.

A conduit may be provided extending from the bottom of the distillation vessel, through which waste sludge can freely pass for collection in a waste receptacle. Thus, the invention provides a solvent recycler having a distillation vessel with heating means in the form of a “top down” heating means or indirect heating means surrounding said vessel and means for automatically providing for waste removal from said distillation vessel during operation of the recycler without necessity for opening said distillation vessel for access thereto to remove said waste.

### BRIEF DESCRIPTION OF THE DRAWINGS

Embodiments of the present invention will now be described, by way of example only, with reference to the attached Figures, wherein:

FIGS. 1 and 2 show prior art recyclers as described in the Mansur and Yamamoto patents referred to above;

FIGS. 3-26 and 30-33 are schematic views of parts washers according to various embodiments of the invention;

FIGS. 27 and 28 are schematic views of recyclers according to various embodiments of the invention; and

FIG. 29 is a schematic view of a combination recycler according to FIG. 28 and a parts washer according to FIG. 3.

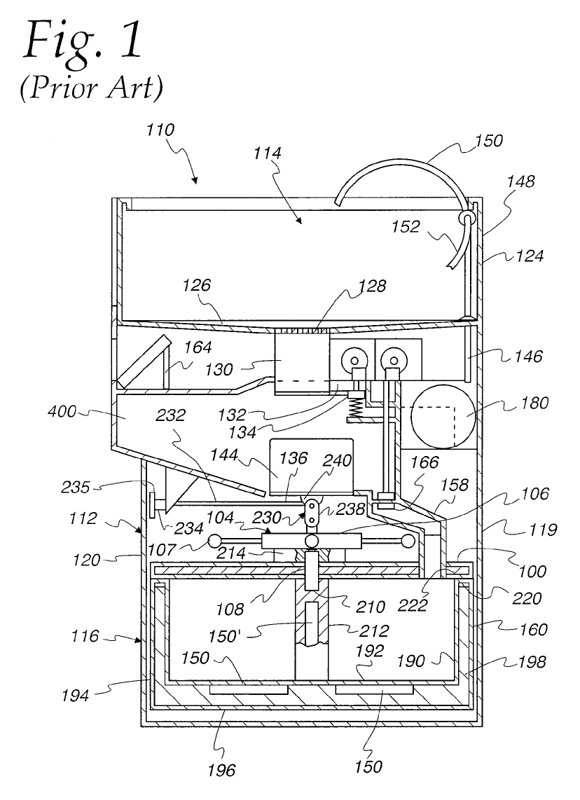

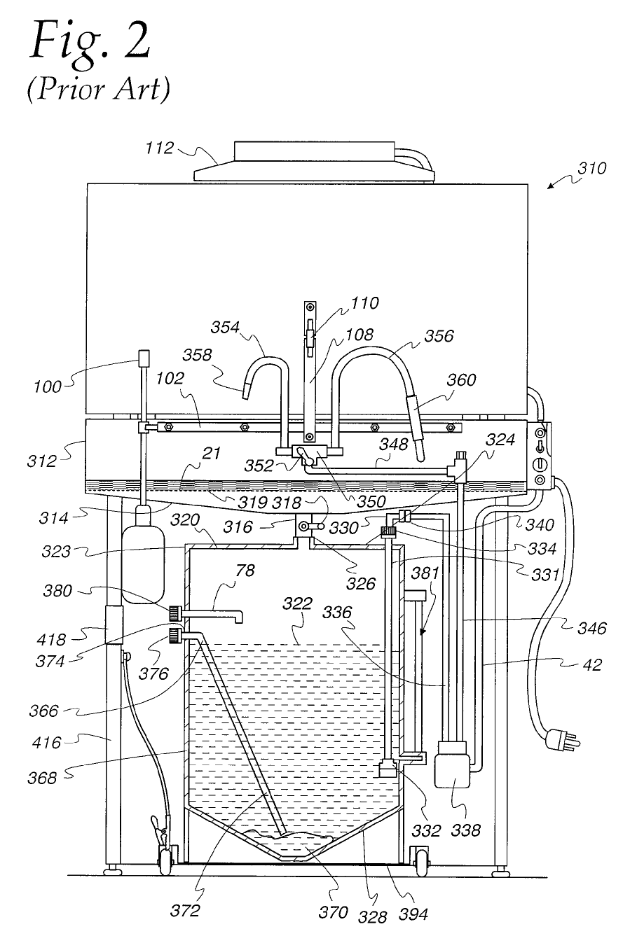

### DETAILED DESCRIPTION

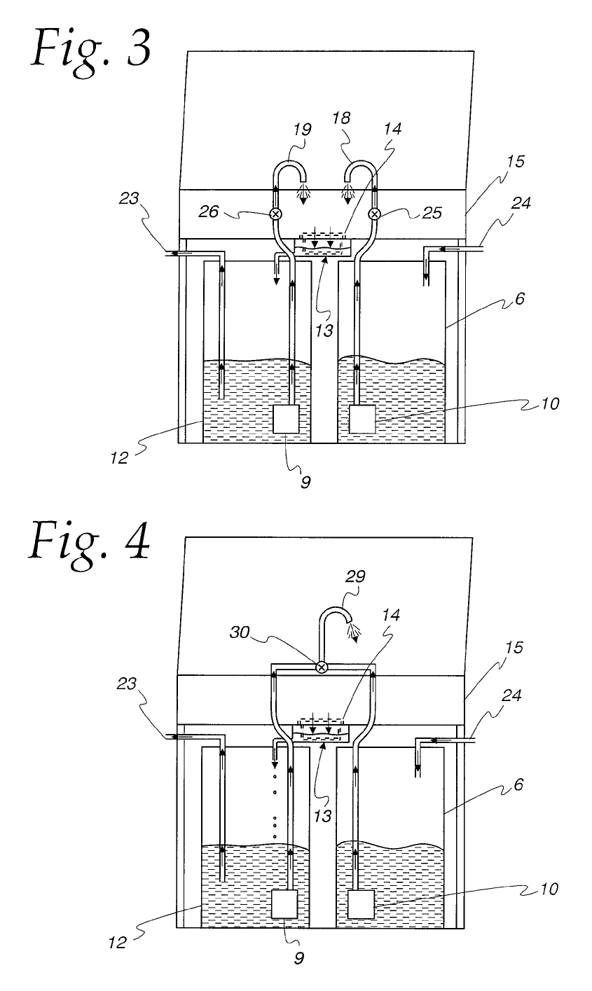

Referring to FIG. 3, the parts washer comprises a sink 15, which is provided with primary and secondary filter drains 14 and 13. For the purpose of cleaning parts placed in the sink, clean solvent is introduced through a spout 18 and used solvent is introduced through a spout 19. Clean solvent is pumped to spout 18 from a clean solvent supply drum 6 by means of a pump 10. Used solvent is pumped to spout 19 from a used solvent supply drum 12 by means of a pump 9. Contaminated solvent exits sink 15 through primary and secondary filter drains 14 and 13 and drains into drum 12. Contaminated solvent passes from drum 12 to an inlet 23 of a solvent recycler (which may be in the form of a “black box” which is separate from the parts washer) and clean solvent passes from an outlet 24 of the recycler to drum 6. The individual flows of clean and used solvent from drums 6 and 12 through the spouts 19 and 18 may be regulated by means of manually operated flow controllers 25 and 26 (hereinafter called “valves”) which are preferably in the form of switches controlling the power to pumps 10 and 9, and thus operate as flow control valves.

In the embodiment of FIG. 4, the parts washer is the same as FIG. 3, except that only a single spout 29 is provided, which is fed from drums 6 and 12 through a flow controller 30 (hereinafter called a “mixing valve”) controlling the power to pumps 10 and 9 and which also functions as a mixing valve for adjusting the mixture of clean and used solvents.

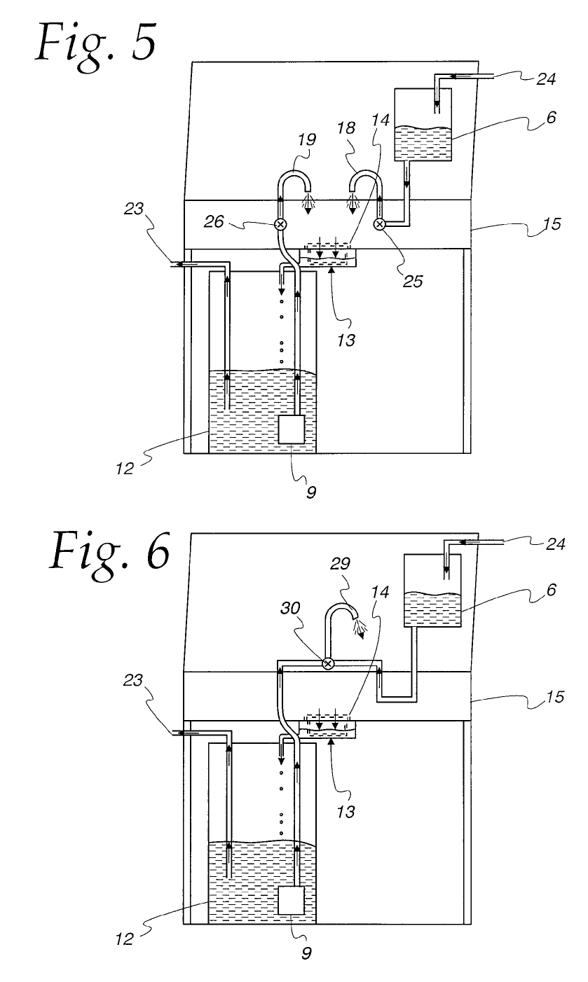

In the embodiment of FIG. 5, the parts washer is again the same as FIG. 3, except that the clean drum 6 is located above the sink 15 and clean solvent is fed by gravity to the spout 18, thereby eliminating the need for a pump 10.

In the embodiment of FIG. 6, the parts washer is the same as FIG. 5, except only a single spout 29 is provided, which is fed from drums 6 and 12 through a mixing valve 30.

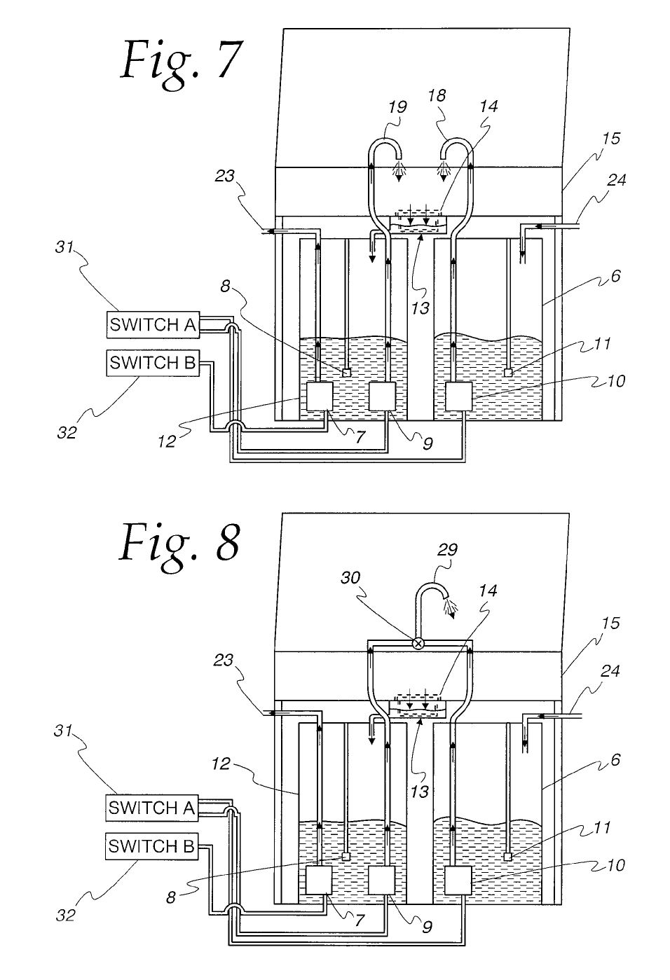

In the foregoing embodiments, the parts washer and the inlet and outlet to the recycler are controlled manually. In the embodiment of FIG. 7, the parts washer is the same as FIG. 3, with the following additions, which provide automatic control of the parts washer and also the inlet and outlet to the recycler. The pumps 9 and 10 are supplied through an electrical circuit including a two-way switch A, which in its default position supplies power to pump 10. Switch A is activated by a float valve 11 extending into drum 6 and float valve 11 is linked to switch A such that in the raised position of the float valve, the switch is in its default position connecting the power supply to pump 10. However, in the lowered position of the float valve 11, the switch is actuated to connect the power supply to pump 9.

Drum 12 contains a pump 7, which pumps contaminated solvent out of drum 12 to the recycler inlet 23. Pump 7 is supplied through an electrical circuit including a switch B which is activated by a float valve 8 extending into drum 12 and float valve 8 is linked to switch B such that in the raised position of the float valve, the switch is in its closed position connecting the power supply to pump 7. In the lowered position of the valve 8, switch B disconnects pump 7 from the power supply.

Prior to use of the parts washer, drum 6 is charged with clean solvent With sufficient solvent in drum 6, float valve 11 is maintained in its raised position and maintains switch A in its default position whereby power is connected to pump 10 to pump clean solvent through spout 18 to the parts to be cleaned. When the clean solvent supply in drum 6 is depleted, float valve 11 drops to a point at which it activates switch A to open the connection to pump 10 and close the connection to pump 9. Used solvent is now pumped through spout 19 to the parts to be cleaned. Contaminated solvent from the washing operation collects in the sink 15 and drains into drum 12, thus replenishing the used solvent supply.

It will be seen from the foregoing description that used solvent in drum 12 is automatically replenished by contaminated solvent from the washing operation but the clean solvent in drum 6 becomes depleted unless it is replaced. Such replacement can be accomplished either by replacing the drum 6 with a fresh drum of clean solvent or by recycling the used solvent from drum 12 by means of a recycler as referred to above. When float valve 8 senses sufficient used solvent in drum 12, it activates switch B to close the connection to pump 9, at which time, used solvent is pumped to the recycler. Clean solvent from the recycler is introduced into drum 6 and replenishes the clean solvent supply until the float valve 11 rises to the point where it activates switch A to disconnect pump 9 from the power supply and connect pump 10, whereby clean solvent is now pumped through spout 18.

Regarding the solvent supply to spouts 18 and 19, the float valve 11 may be over-ridden and the switch A operated manually to activate either or both of pumps 9 and 10, in order to supply clean solvent from drum 6 and/or used solvent from drum 12, whereby not only clean or used solvent but also a mixture thereof may be provided, if desired.

In the embodiment of FIG. 8, the parts washer is the same as FIG. 7, except that only a single spout 29 is provided, which is fed from drums 6 and 12 through a mixing valve 30.

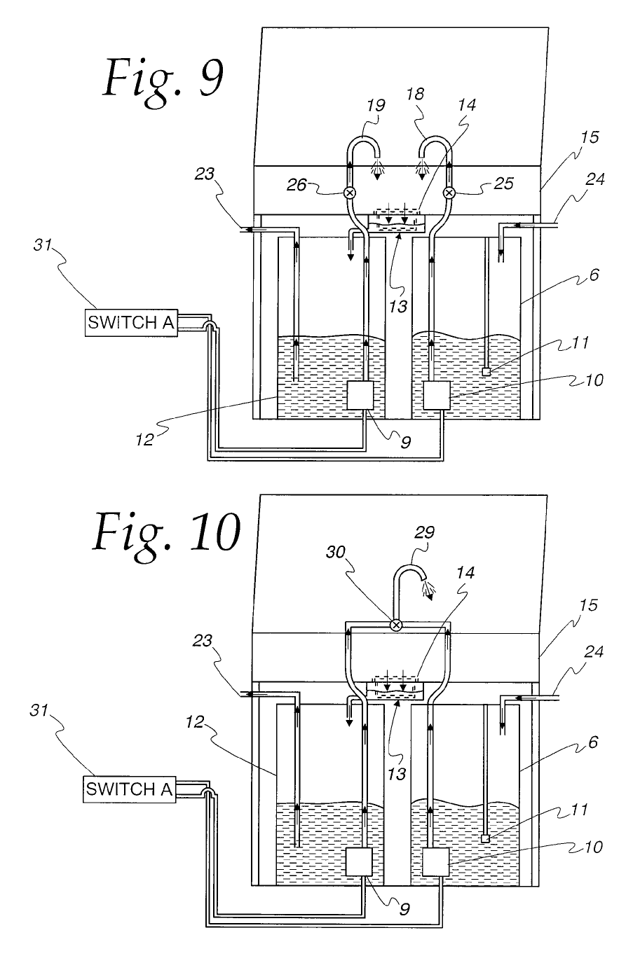

FIGS. 9 and 10 are similar to FIGS. 7 and 8, respectively, except that the used solvent is fed to the recycler by means other than the pump 7, whereby the float valve 8 and switch B are redundant. Thus, the inlet and outlet to the recycler are under manual control but the parts washer is controlled automatically.

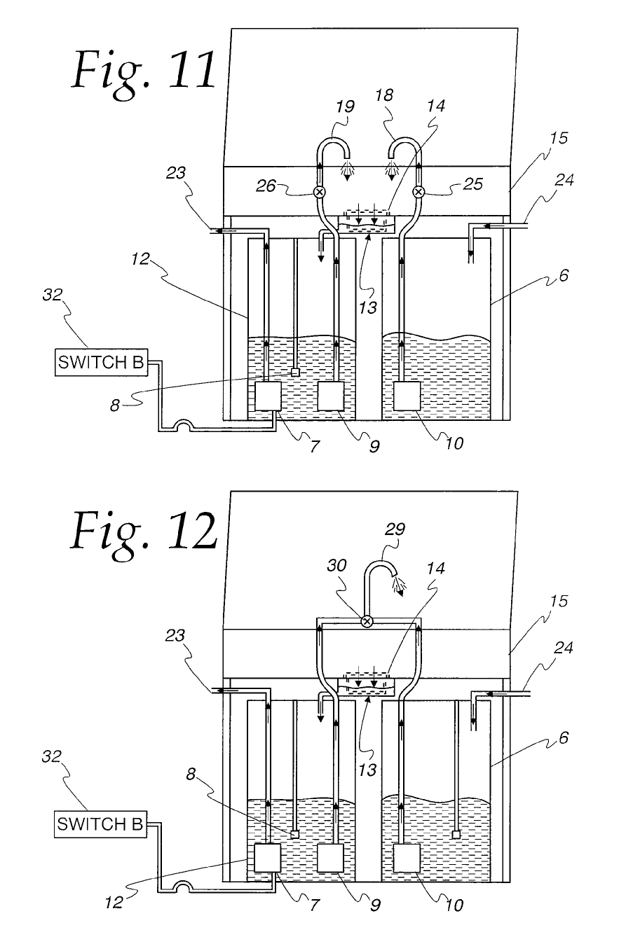

FIGS. 11 and 12 are similar to FIGS. 7 and 8, respectively, except that pumps 9 and 10 are actuated manually, whereby float valve 11 is redundant. Thus, the inlet and outlet to the recycler are under automatic control but the parts washer is controlled manually.

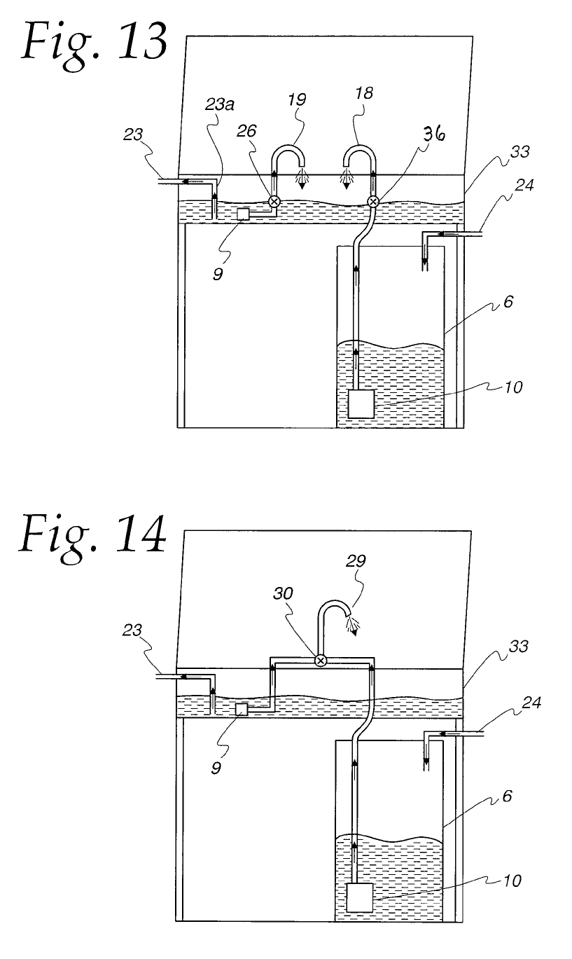

FIGS. 13 and 14 are similar to FIGS. 3 and 4, respectively, except that used solvent collecting in the sink 15 is not drained into the used solvent drum 12 as in the foregoing embodiments but is pumped directly to spout 19 from sink 15 by means of pump 9, thus obviating the need for drum 12. This is a so-called “vat system”. Contaminated solvent passes from directly from sink 15 through pick up tube 23a to solvent recycler inlet 23. Thus, the parts washer and the inlet and outlet to the recycler are controlled manually.

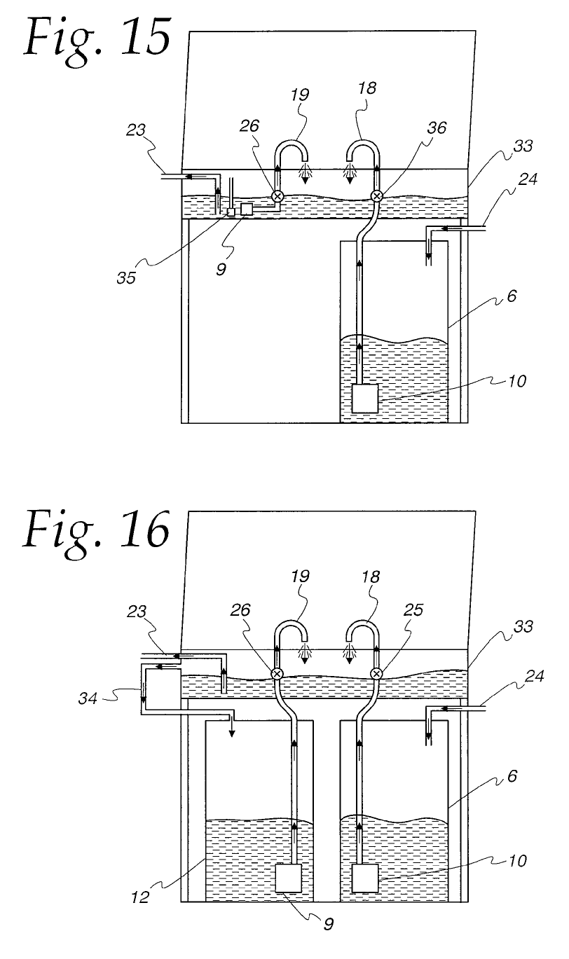

A modification of FIG. 13 is shown in FIG. 15. In this case, a level indicator 35 detects when the sink is empty or the level 33 of solvent in or below a predetermined level (i.e., when most or all used solvent has been recycled to drum 6) and at that point, the level indicator actuates a switch 36 to start pump 10 to feed spout 18 from clean drum 6. If desired, level indicator 35 can also actuate switch 36 to turn off pump 10 when the level of solvent in the sink has risen to a set level, Switch 36 can also be actuated manually to start pump 10.

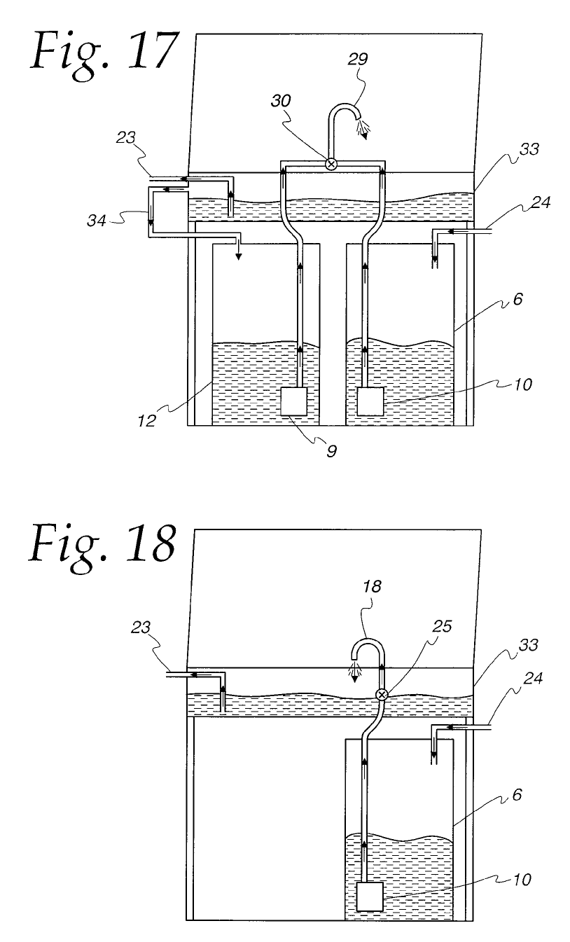

FIGS. 16 and 17 are similar to FIGS. 13 and 14, respectively, except that a used solvent supply drum 12 is used and solvent is pumped to the spout 19 by means of pump 9. In this case, a drain and overflow arrangement 34 is provided whereby when the solvent level in sink 15 reaches a predetermined level set by the height of the overflow conduit 34, solvent drains into the drum 12. Again, contaminated solvent passes from directly from sink 15 to solvent recycler inlet 23.

FIG. 18 is similar to FIG. 13 with the exception that only one spout, namely, spout 18 for clean solvent is used. Thus, spout 19 and pump 9 are eliminated.

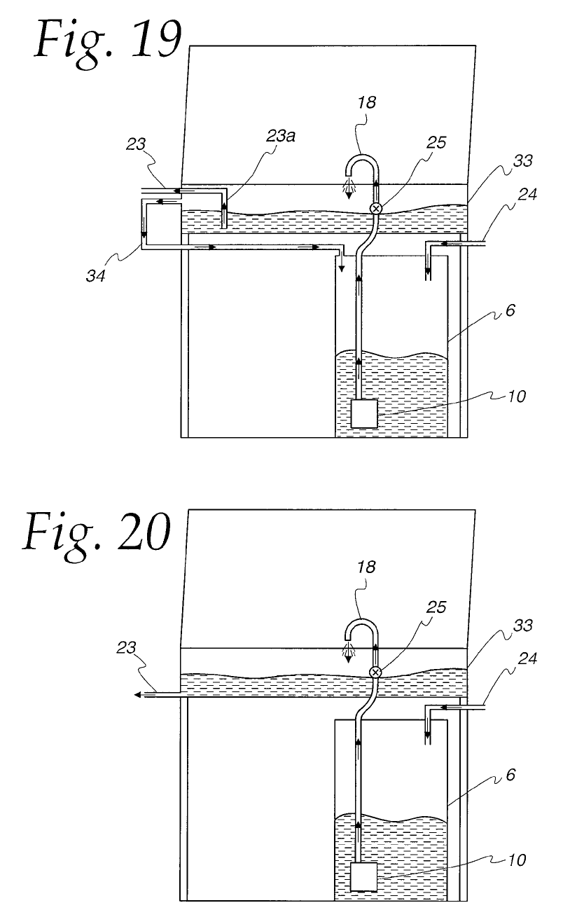

FIG. 19 is similar to FIG. 18 with the exception that a drain and overflow arrangement 34 is provided, as in FIGS. 16 and 17 except that the outlet from 34 drains into clean drum 6. Thus, when the solvent level in sink 15 reaches a predetermined level set by the height of the overflow conduit 34, solvent drains into the drum 6. Again, contaminated solvent passes from directly from sink 15 through a pick up tube 23a to solvent recycler inlet 23.

FIG. 20 is similar to FIG. 18, except that the solvent recycler inlet 23 is located at the bottom of the sink 15 instead of using a pick up tube.

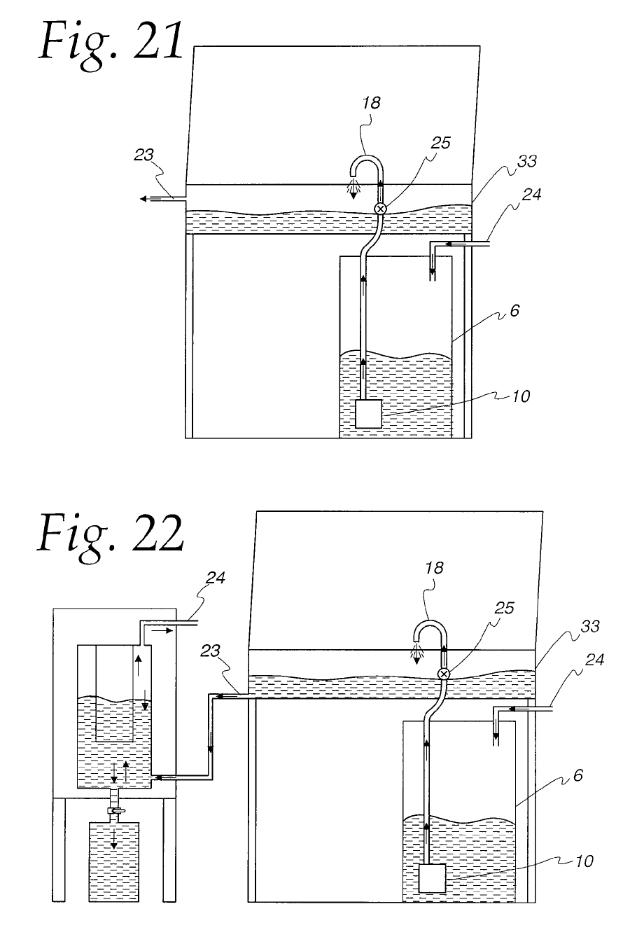

FIG. 21 is similar to FIG. 20, except that the solvent recycler inlet 23 is located at a selected level in the sink 15 instead of using a pick up tube, so that solvent only passes to the recycler when the solvent 33 reaches the selected level.

FIG. 22 shows the parts washer of FIG. 20 with the inlet 23 being the inlet of a recycler of the type described in our co-pending application Ser. No. 60/986,834 filed Nov. 9, 2007, entitled Solvent Recycler, filed concurrently herewith, the contents of which are incorporated herein by reference. In this case the recycler is positioned alongside the sink 15 so that the level 33 in the sink controls the level of solvent in the distillation chamber of the recycler. Clean solvent from the recycler outlet 24 passes into clean drum 6.

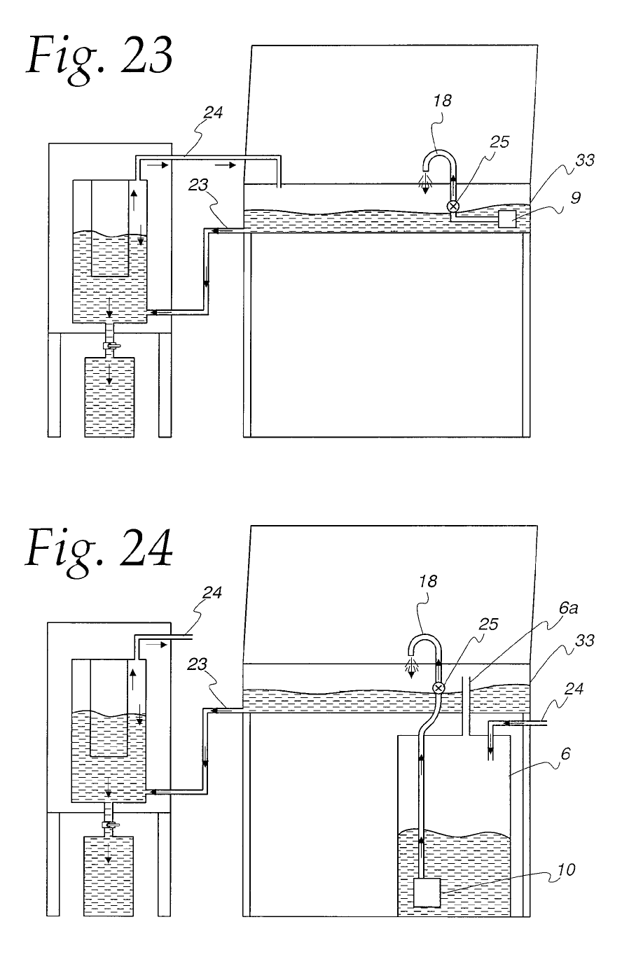

FIG. 23 is similar to FIG. 22, except there is no clean drum 6 and clean solvent from the recycler outlet 24 passes back into sink 15. Thus, this embodiment obviates the need for a filling tube or clean drum and the solvent level in the distillation chamber of the recycler is controlled by the solvent level 33 in the sink, the entire system having no need for valves or pumps.

FIG. 24 is similar to FIG. 22, except that a tube 6a is provided extending upwardly from the clean drum 6 and terminating above the level 33 of solvent in the sink 15. This provides a means for solvent in the drum 6 to overflow into sink 15, thus maintaining availability of solvent for use in the sink and also maintaining the availability of clean solvent through spout 19.

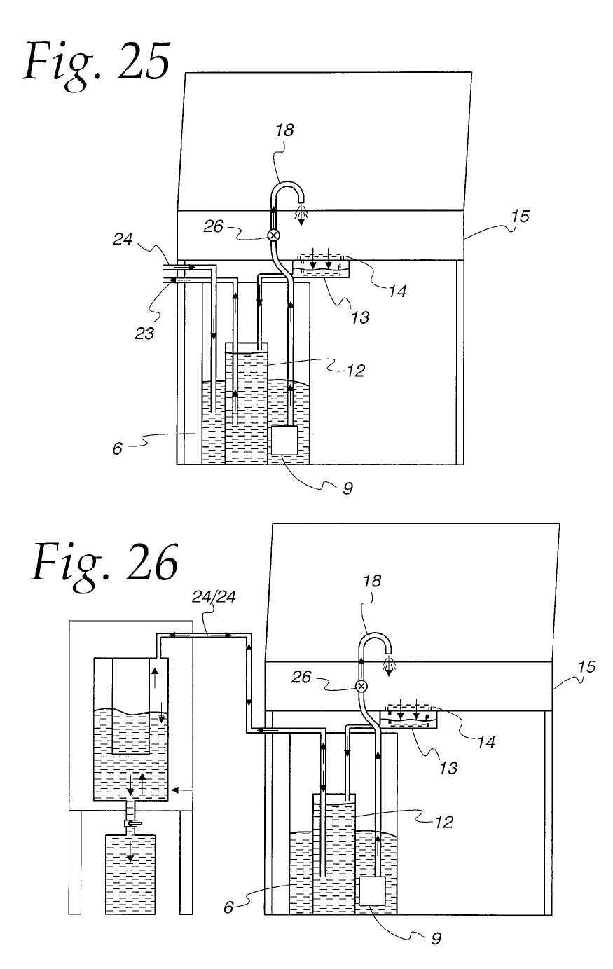

FIG. 25 shows a modification of the two-drum system wherein the used solvent supply drum 12 is located inside the clean drum 6. The drum 12 is of a smaller volume than the clean drum 6, so as to ensure a certain amount of overflow to ensure solvent is always available for use. Although this leads to the possibility of used solvent dirtying the clean, any overflow into the clean container would be the cleanest of the used solvent, and this would only happen if the recycler was not fast enough. However, even if the recycler is not fast enough, the recycler would still benefit from sucking in the dirtiest used solvent from the bottom of the used solvent in drum 12 and it would not be sucking clean solvent being put into a separate container.

FIG. 26 is similar to FIG. 25, except that a single conduit extends into the dirty drum 12, which is connected to the combined inlet/outlet 23/24 of a recycler operating in accordance with that described in our co-pending application Ser. No. 10/537,316, the entire contents of which are incorporated herein by reference. In such a recycler, during the distillation cycle, the vapour passes out of the distillation vessel through inlet/outlet 23/24 and during cool-down, because the system is closed, the condensation of the vapour in the distillation chamber and the conduit, as it cools, creates a vacuum which is used to draw solvent from drum 12 for recycling. It may be noted that the “drum within a drum” system of FIGS. 25 and 26 can be applied to any of the embodiments of FIGS. 3, 4, 7, 8, 9, 10 and 29, with appropriate modifications.

A significant advantage of coupling a recycler to the parts washer is the ability to use a relatively small drum for the clean solvent. Typically, a 30 gallon container is used in a conventional parts washer in order to avoid the necessity for storing a large number of drums on-site and for frequent replacement of the empty drums by full drums as the small drums are rapidly depleted by the washing operations. By recycling the solvent, the clean solvent supply is automatically replenished and a standard 5 or 16 gallon drum can be used for a relatively long period before it needs to be replaced by a fresh drum. Any suitable type of recycler may be employed for recycling of the solvent from the used solvent drum—for example, the recycler described in our U.S. application Ser. No. 10/030,027, the entire contents of which are incorporated herein by reference.

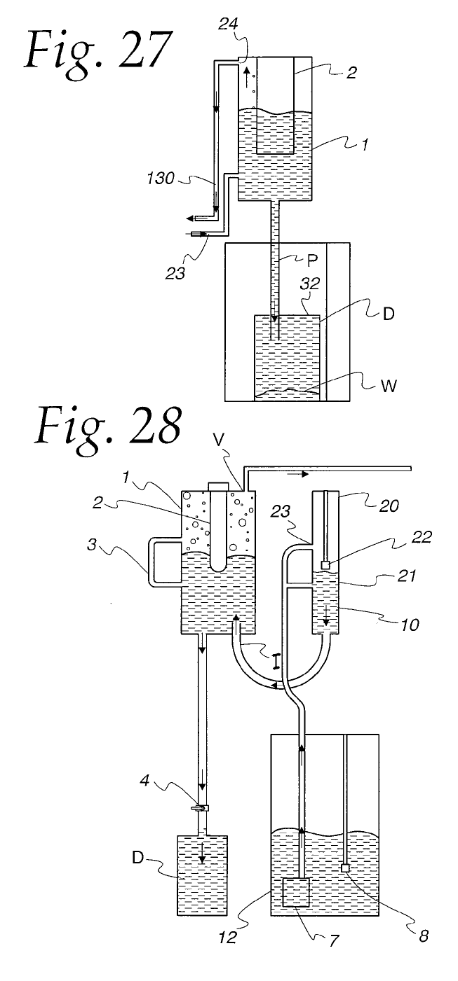

FIG. 27 shows a novel recycler, which may be used in association with the parts washer or in other applications. The recycler comprises a distillation vessel 1 having an inlet 23 for used solvent and a solvent vapour outlet 24. A heating means 2 extends downwardly into the distillation vessel. The inlet 23 is located below the level of the heating means 2. The solvent vapour outlet 24 is located close to the top of distillation vessel 2. Thus, used solvent is drawn, pumped or drained into distillation vessel 1, the heating means is activated to elevate the temperature of the used solvent in the distillation vessel to its boiling point and the solvent vapour is distilled off and exits through outlet 24. Waste W from the distillation process in the form of sludge drops through an outlet pipe P in the floor of distillation vessel 1 into a collection drum D. Alternatively, collection drum D may be dispensed with and sludge collected on the bottom of distillation vessel 1. In both cases, the solvent feed enters the distillation vessel 1 beneath the distillation zone surrounding the heating means 2 so that the waste sludge drops away from the solvent into the collection drum D in the case of FIG. 21 or a waste collection zone at the bottom of distillation vessel 1, as the case may be, before it has an opportunity to contaminate the distillation zone. It will be appreciated that the distillation chamber can be filled through the top of the distillation chamber instead of below the level of the heating means, if desired. In that case, it is desirable that the inlet be so positioned relative to the distillation zone that waste from the distillation process is allowed to drop through the outlet pipe P into collection drum D or to the bottom of distillation vessel 1, before it can contaminate the distillation zone.

The heating means 2 (which would typically comprise a jacketed heating element extending down into the solvent within the vessel 24) could be replaced by a microwave or infrared heating element or an indirect heating means, such as a heated oil bath surrounding the distillation vessel.

Referring now to FIG. 28, there is shown a further embodiment of the novel recycler. The recycler comprises a distillation vessel 1 having an inlet I for used solvent and a solvent vapour outlet V. A heating means 2 extends downwardly from the top of the chamber into the distillation vessel. Again, the solvent feed enters the distillation vessel 1 beneath the distillation zone surrounding the heating means 2 so that the waste sludge drops away from the solvent into the collection drum D. In this case, a shut off valve 4 is provided to close the exit conduit from the distillation vessel 1, so that the collection drum can be removed for disposal and replaced with a new drum. The used solvent is fed from used solvent supply drum 12 by means of a pump 9 through inlet 23 and a filling tube 21 fitted with a level indicator 22. FIG. 28 shows a two-line feed from inlet 23 into the filling tube but a single line feed may be used instead. A vent 20 is provided on the filling tube. If desired, the filling tube 21 can be gravity fed from the drum 12, which eliminates the need for pump 7. Level indicator 22 is used on start-up of the recycler when it is in the cold state and is arranged to shut off pump 7 when the solvent level in the filling tube reaches a predetermined level and thus prevent over-filling of the distillation vessel 1. The vessel 1 is also provided with a distillation chamber liquid level indicator tube 3. This tube may be provided with a temperature probe (not shown) which monitors the temperature of the tube, since the fluid in the distillation chamber being at a high enough level within the distillation chamber will be reflected by the temperature of the tube and the temperature probe extrapolates therefrom the level of the liquid accordingly. Further, to ensure the tube is affected solely by the temperature of the liquid in the tube, the connection of the tube to the distillation chamber is of a non-heat conductive material. One example of many suitable materials is Teflon. It is further understood the tube may be used in conjunction with a distillation chamber made entirely from a non-heat conductive material, provided the tube itself is of a material of which a probe or sensor is able to sense the temperature as a result of fluid being present within said tube or not. The probe is also arranged to shut off pump 7 so as to prevent over-filling of the distillation vessel. The distillation chamber liquid level indicator is a novel feature in itself, which may be applied to any recycler.

Used solvent is pumped from drum 12 to distillation vessel 1, and the heating means 2 is activated to elevate the temperature of the used solvent in distillation vessel 1 to its boiling point, at which point solvent vapour is distilled off and exits through outlet V.

Thus, it may be seen that the novel recycler enables the periodic feed of used solvent into the distillation chamber without the need to open said chamber and while the heating means is either on or off and without the need for any valves in the liquid flow path. The system eliminates any kind of clogging in the inlet portion feed of any batch or non-batch recycling system. Also, the distillation chamber is able to be much smaller than in conventional recyclers as it is not required to have sludge holding capacity and or recycling means encumbered by holding sludge, as the sludge is collected in a separate sludge zone, all without the distillation or recycling means needing to be interrupted to empty sludge from distillation chamber. Also, the sludge zone upon service or install may be filled with clean solvent acting as an automatic top off to the system it is drawing from, such as a parts cleaner. Parts cleaners lose solvent from carry off, which in conventional and prior art is not replenished. The novel recycler allows for automatic top off/replenishment of solvent as the sludge, being heavier than solvent, will fall to the bottom of the sludge container, displacing clean solvent from the sludge collection container into the distillation chamber/zone, thus being distilled or recycled by the recycling means back into the parts cleaner and thus extending the length of time before new solvent is needed to be added to the system. The novel recycler also allows for automatic filling of the distillation chamber upon first install as compared to it needing to be filled manually.

Referring now to FIG. 29, there is shown the recycler of FIG. 28 integrated with the parts washer of FIG. 3. Again, the recycler comprises a distillation vessel 1 having an inlet I for used solvent and a solvent vapour outlet V. In this case, the solvent vapour outlet V connects with recycler outlet 24 through condensing coils 16 and 17. Thus, used solvent is pumped from drum 12 to distillation vessel 1, through recycler inlet 23 and filling tube 21, and the heating means 2 is activated to commence distillation. Vapour exiting the distillation vessel condenses in coils 16 and 17 and passes through line recycler outlet 24 into drum 6 in the form of clean liquid solvent. Note that the used solvent is able to continually be pumped to the recycling/distillation unit without interruption of solvent available for use by the user.

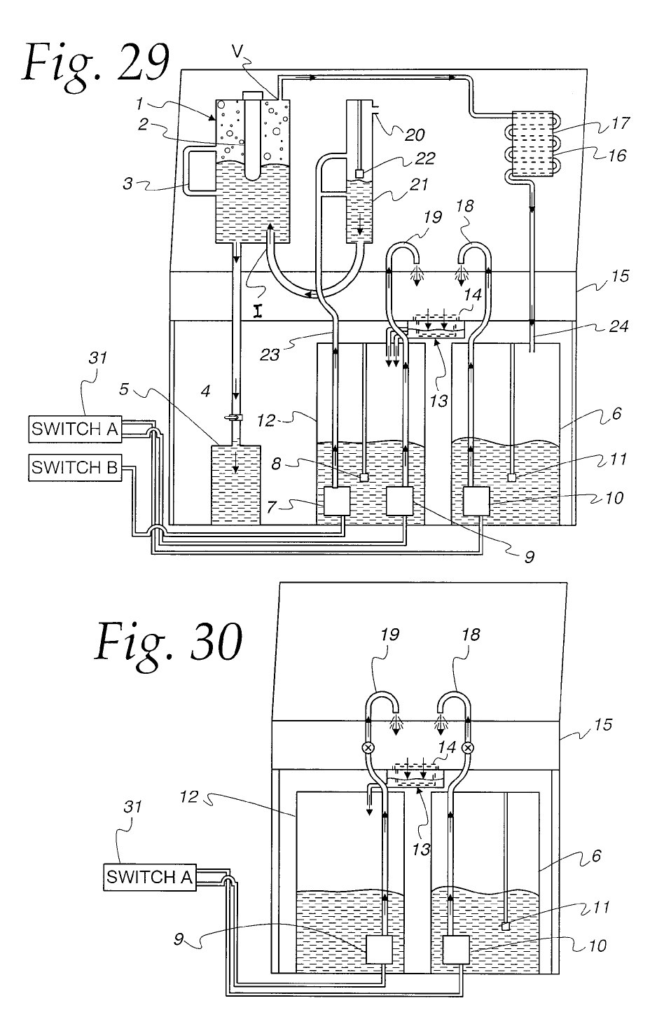

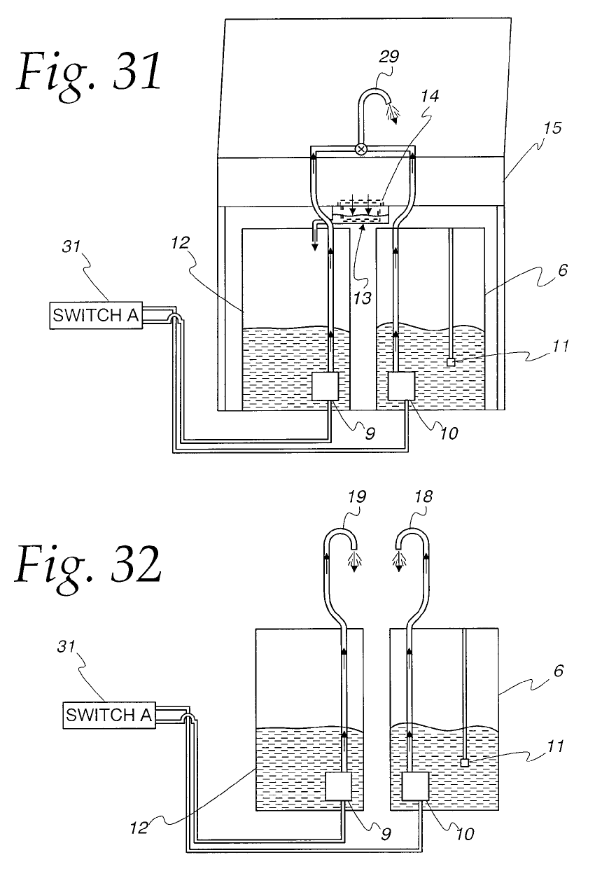

FIGS. 30 and 31 are similar to FIGS. 9 and 10, with automatic switching between drums 6 and 12 by means of float valve 11 operating upon switch A to selectively actuate pump 10 or pump 9, but minus connections to a recycler.

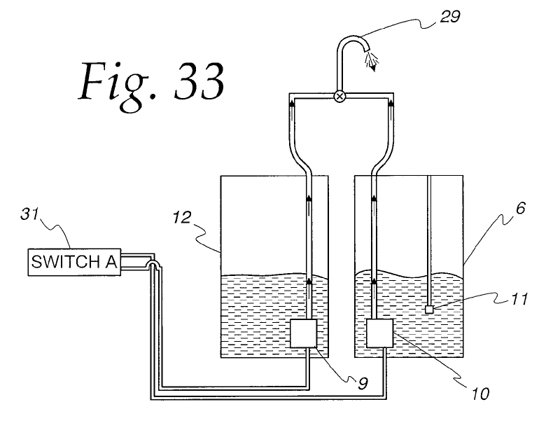

FIGS. 32 and 33 are similar to FIGS. 30 and 31, but minus the sink 15 in order to illustrate that the solvent supply system may be used with any suitable wash station.

1. A parts cleaner for use in a process whereby solvent is preferred to always be available and is preferred to be as clean or pure as possible for use, comprising containers respectively for clean solvent and for capture of used solvent, said clean container having an outlet for supplying clean solvent for cleaning and an inlet for clean recycled solvent, said used solvent container having an inlet for used solvent, an outlet for supplying used solvent for cleaning and an outlet for supplying used solvent for recycling.

2. A parts cleaner as in claim 1, wherein means are provided for manually switching between said clean solvent and said used solvent for cleaning.

3. A parts cleaner as in claim 1, wherein means are provided for automatically switching between said clean solvent and said used solvent for cleaning.

4. A parts cleaner as in claim 1, wherein means are provided for triggering said used solvent to be supplied for recycling.

5. A parts cleaner as in claim 1, wherein said outlet for supplying used solvent for recycling is in the form of a pick up tube extending into said used solvent container.

6. A parts cleaner for use in a process whereby solvent is preferred to always be available and is preferred to be as clean or pure as possible for use, comprising containers respectively for clean solvent and for capture of used solvent, said clean container having an outlet for supplying clean solvent for cleaning and said used solvent container having an outlet for supplying used solvent for cleaning and means for automatically switching between said outlets supplying said clean solvent and said used solvent for cleaning.

7. A parts cleaner as in claim 6, wherein said used solvent container is located within but separate from said clean container.

8. A parts cleaner as in claim 7, wherein said clean container has an inlet for clean recycled solvent and said used solvent container has an outlet for supplying used solvent for recycling.

9. A parts cleaner as in claim 7, wherein said clean has an inlet for clean recycled solvent and said used solvent zone has an outlet for supplying used solvent for recycling.

10. A parts cleaner for use in a process whereby solvent is preferred to always be available and is preferred to be as clean or pure as possible for use, comprising containers respectively for clean solvent and for capture of used solvent, said clean container having an outlet for supplying clean solvent for cleaning and an inlet for clean recycled solvent, said used solvent container having an inlet for used solvent, an outlet for supplying used solvent for cleaning and an outlet for supplying used solvent for recycling, said parts cleaner adapted to draw first from the clean solvent container and drain into a separate used solvent container and when clean solvent is not available, to draw from the used solvent container, thus ensuring availability of solvent at all times.

11. A parts cleaner as in claim 10, wherein used solvent is passed through an outlet extending from the bottom of the used solvent collection container to a recycler and returned through an inlet to the clean solvent container from which the system will begin to draw upon availability of the clean solvent, whereby the cleanest solvent is always used first and the used solvent, whenever used, is ensured to be as clean as possible.

12. A parts cleaner as in claim 10, wherein clean solvent accumulates to a certain volume before initiating draw for use.

13. A parts cleaner as in claim 10, wherein the method of initiating clean solvent as the first draw may be via a sensing means.

14. A parts cleaner as in claim 1, further comprising remote monitoring means for remote monitoring of said parts cleaner and the condition and/or operation thereof.

15. A solvent recycler having a distillation chamber and a filling system for the distillation without the use of valves when filling the distillation chamber used solvent.

16. A solvent recycler as in claim 15, having a conduit extending from the bottom of the distillation vessel, through which waste sludge can freely pass for collection in a waste receptacle.

17. A solvent recycler as in claim 14, having a distillation vessel with heating means in the form of a “top down” heating means and means for automatically providing for waste removal from said distillation vessel during operation of the recycler without the necessity for opening said distillation vessel for access thereto to remove said waste.
